(19) United States
(12) Patent Application Publication
(10) Pub. No.: US 2005/0008186 A1
(43) Pub. Date: Jan. 13, 2005

(54) Sealing composition for inflated articles

(75) Inventors: Terry A. Kingsmore JR., Pflugerville, TX (US); Patrick Desbois, Austin, TX (US); Mohammed K. Hijazi, Austin, TX (US); Jeffrey S. Layton, Round Rock, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 10/615,576

(22) Filed: Jul. 8, 2003

(51) Int. Cl. H04R 1/02; H01M 2/10

(52) U.S. Cl. 381/386; 429/98

(57) ABSTRACT

In a speaker assembly in a portable device information handling system, a battery is operable to provide power to the portable device. The battery includes a plurality of cells housed in a battery housing. A predefined number of cells included in the plurality of cells are removable to define a selective portion of the battery housing. The speaker assembly housed in a speaker container is installable in the selective portion. The dimensions of the battery housing having the speaker container installed in the selective portion are substantially unchanged. A terminal connector assembly having a plurality of electrical connectors couples the battery and the speaker assembly to external devices. The speaker assembly includes a speaker operable to output sound having a low frequency.

### BACKGROUND

The present disclosure relates generally to information handling systems, and more particularly to techniques for enhancing effects of multimedia applications in portable information handling system components such as notebook computers, personal digital assistants, and gaming consoles.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Today, due to advances in multimedia applications such as digital video disc (DVD) movies and/or electronic games deploying the latest in audiovisual effects, coupled with the advances in audiovisual technology being incorporated in some information handling system devices such as personal computers, users are able to enjoy theater-like surround sound experience on their desktop computing systems.

However, users of portable information handling system devices such as notebook computers have generally been unable to enjoy the same theater-like sound experience. This limitation has been generally attributed to severe space and power consumption constraints applicable to the portable devices. With users of portable devices continually demanding that these devices be lighter, smaller and consume less power than the earlier generation technology, the possibility of offering improved sound experience becomes challenging.

Most multimedia portable devices available today include a stereo sound card coupled to a pair of internal speakers, which is capable of producing sound having a limited audio frequency range. Since the internal speakers are typically small in size (due to space constraints), the speaker output generally sounds metallic due to an inadequate bass or low frequency component. Presently, some portable information handling system devices offer connections to external speakers to enhance the sound. However, this reduces the portability of the device and consumes more power.

Therefore, a need exists to improve audio performance of portable devices, especially of low frequency sound components present in multimedia applications. More specifically, a need exist to develop tools and techniques for incorporating a speaker apparatus operable to produce low frequency sounds in a portable device. Accordingly, it would be desirable to provide tools and techniques for improving low frequency sound of multimedia applications included in an information handling system absent the disadvantages found in the prior methods discussed above.

### SUMMARY

The foregoing need is addressed by the teachings of the present disclosure, which relates to a system and method for incorporating a speaker apparatus operable to produce low frequency sounds in a portable device. According to one embodiment, in a method and system for incorporating a speaker assembly in a portable device of the information handling system, a battery is operable to provide power to the portable device. The battery includes a plurality of cells housed in a battery housing. A predefined number of cells included in the plurality of cells are removable to define a selective portion of the battery housing. The speaker assembly housed in a speaker container is installable in the selective portion. The dimensions of the battery housing having the speaker container installed in the selective portion are substantially unchanged. A terminal connector assembly having a plurality of electrical connectors couples the battery and the speaker assembly to external devices. The speaker assembly includes a speaker operable to output sound having a low frequency.

In one embodiment, a method for incorporating a speaker assembly in a portable device of the information handling system, includes utilization of space created by removal of some battery cells from a battery providing power to the device. The battery is enclosed in a battery housing and the speaker assembly is enclosed in a speaker container. The method includes preparing a selective portion of the battery housing by removing a predefined number of batteries and create a space to receive the speaker container. The speaker container is received by the selective portion to maximize the utilization of space. The dimensions of the battery housing remain substantially unchanged before and after receiving the speaker container.

Several advantages are achieved by the method and system according to the illustrative embodiments presented herein. The embodiments advantageously provide for a reduced occurrence of operating conflicts and improved reliability while reducing the number of components.

### BRIEF DESCRIPTION OF THE DRAWINGS

FIG. 1A is a view in perspective of a battery, according to an embodiment;

FIG. 1B is a view in perspective of a battery system with a number of cells removed, according to an embodiment;

FIG. 1C is a view in perspective of a speaker container suitable for housing a speaker assembly, according to an embodiment;

FIG. 1D is a view in perspective of a battery system and a speaker container illustrating matching form factors to facilitate installation, according to an embodiment;

FIG. 1E is a view in perspective of a battery system with a speaker container being installed in a space created by removal of the cells, according to an embodiment;

FIG. 2A illustrates a diagrammatic representation of a battery for incorporating a speaker assembly, according to an embodiment;

FIG. 2B illustrates a diagrammatic representation of a battery for incorporating a speaker assembly and audio electronics, according to an embodiment;

FIG. 3 is a flow chart illustrating a method for incorporating a speaker assembly in a portable device of the information handling system, according to an embodiment; and

FIG. 4 illustrates a block diagram of an information handling system to implement method or apparatus aspects of the present disclosure, according to an embodiment.

### DETAILED DESCRIPTION

Novel features believed characteristic of the present disclosure are set forth in the appended claims. The disclosure itself, however, as well as a preferred mode of use, various objectives and advantages thereof, will best be understood by reference to the following detailed description of an illustrative embodiment when read in conjunction with the accompanying drawings. The functionality of various devices or components described herein may be implemented as hardware (including circuits) and/or software, depending on the application requirements.

Most multimedia portable devices available today provide a stereo sound output through a pair of internal speakers. However, the internal speakers being small in size (due to space constraints), the speaker output generally sounds metallic due to an inadequate bass or low frequency component. It would be desirable to improve the audio performance of the multimedia portable devices, especially low frequency sound components present in multimedia applications. According to one embodiment, a method for incorporating a speaker assembly in a portable device includes creating space for a low frequency speaker (a ‘sub-woofer’) within a battery operable to provide power to the portable device. The space is created by removal of a few battery cells from the battery to accommodate the sub-woofer. Advantageously, the dimensions of the portable device and/or the battery are not affected by the installation of a sub-woofer as an option.

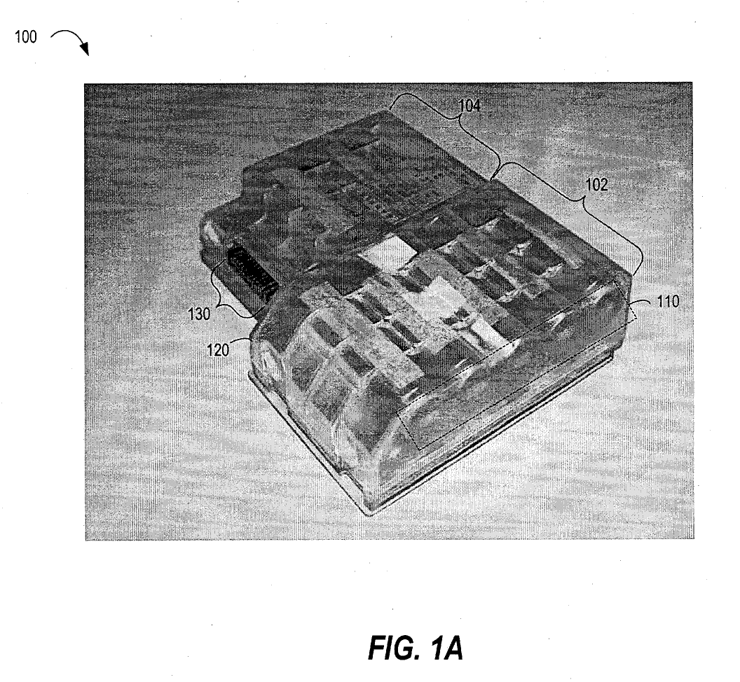

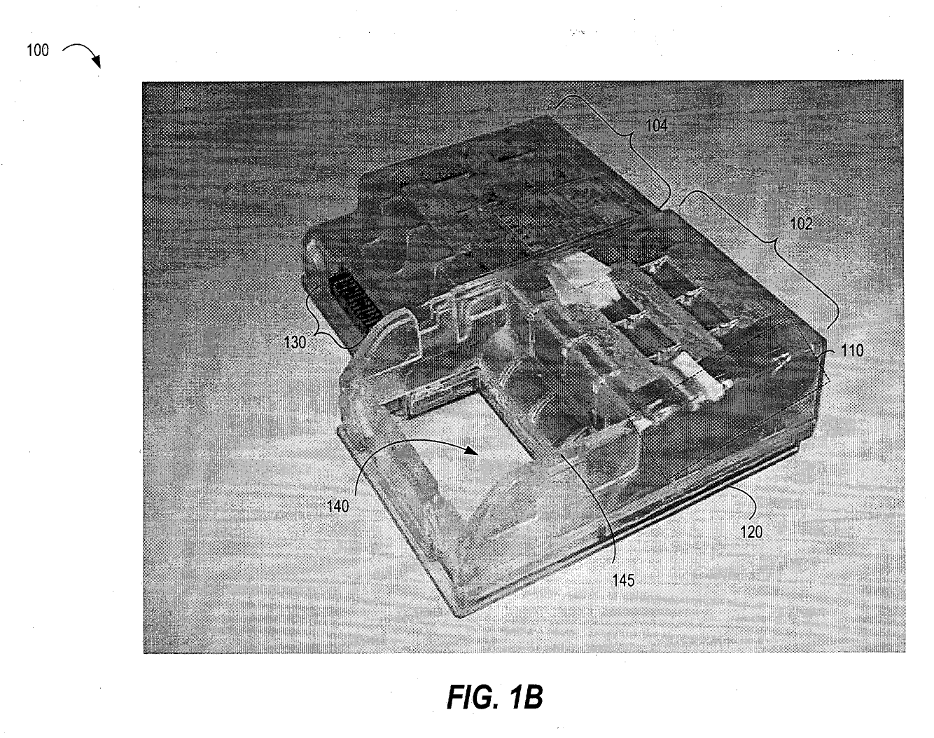

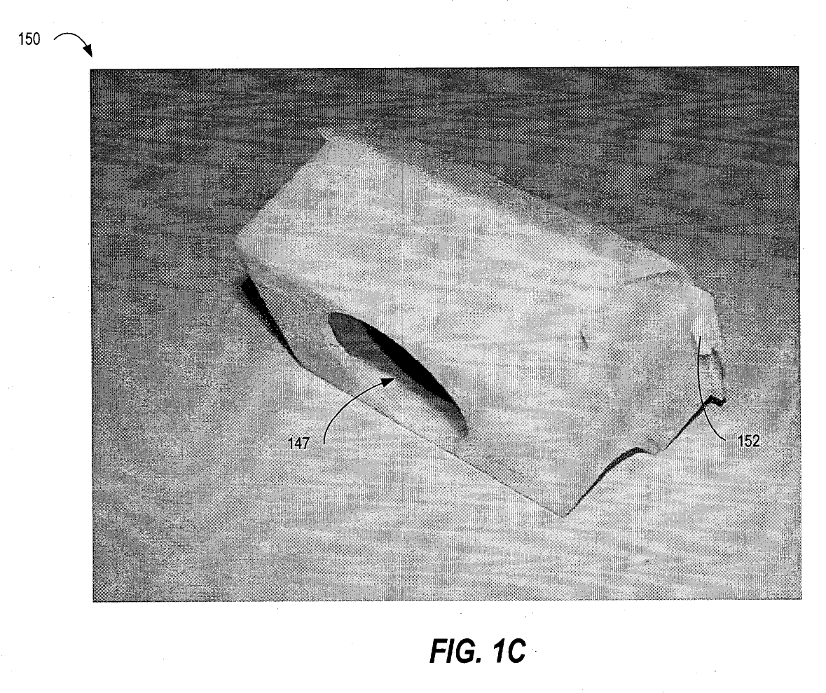

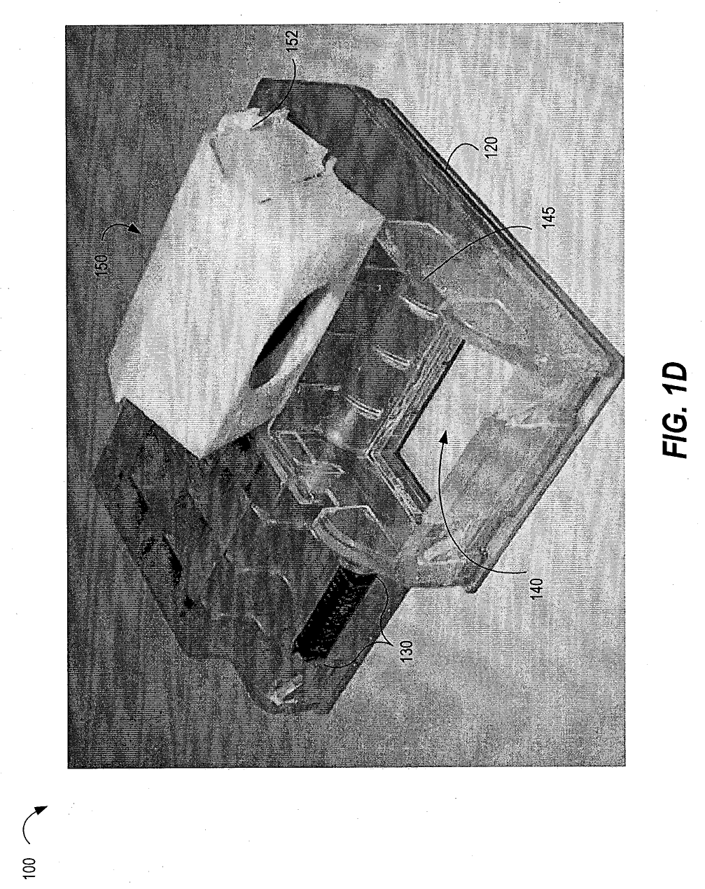

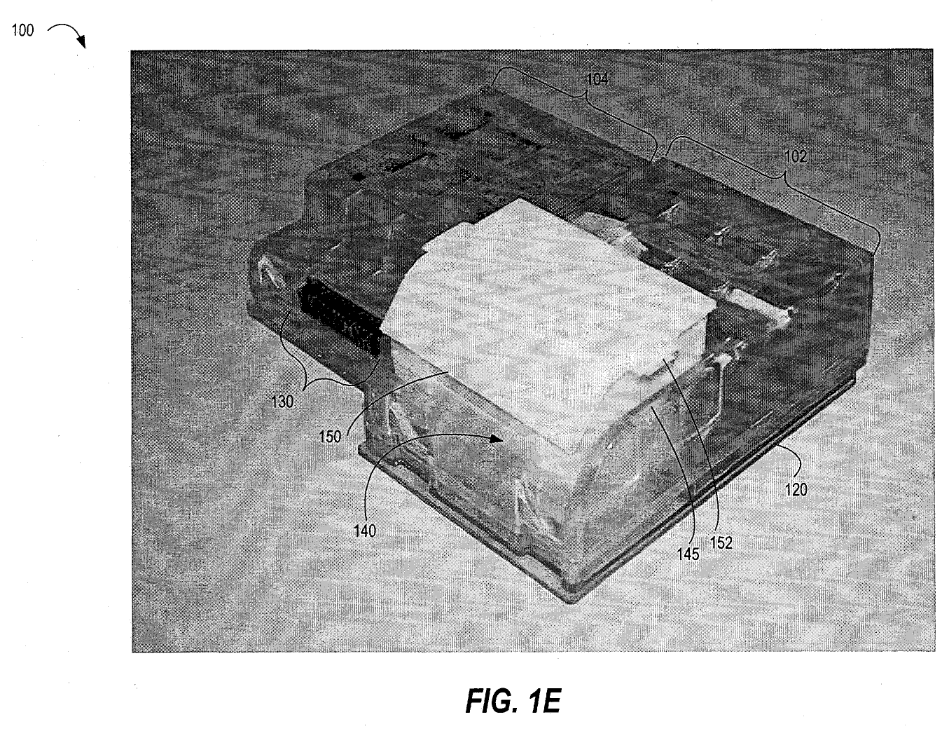

FIG. 1A is a view in perspective of a battery 100, according to an embodiment. In general, a battery converts chemical energy within its material constituents into electrical energy in the process of discharging. A rechargeable battery is generally returned to its original charged state (or substantially close to it) by passing an electrical current in the opposite direction to that of the discharge. Presently well known rechargeable battery technologies include Lithium Ion (LiON), Nickel Cadmium (NiCd), and Nickel Metal Hydride (NiMH). In the past, the rechargeable batteries (also known as “dumb” batteries) provided an unpredictable source of power for the portable devices, since typically, a user of the device powered by the battery. had no reliable advance warning that the energy supplied by the rechargeable battery was about to run out.

Today, through the development of “smart” or “intelligent” battery packs, batteries have become a more reliable source of power by providing information to a device of the information handling system (not shown) and eventually to a user as to the state of charge, as well as a wealth of other information. In one embodiment, the battery 100 is a smart battery. In one embodiment, the battery 100 is a dumb battery. A smart version of the battery 100, is typically equipped with electronic circuitry (not shown) to monitor and control the operation of the battery. The information is typically communicated to a controller (not shown) in the portable device using a well-known System Management Bus (SMBus) (not shown), which is widely used in the industry. Information pertaining to the battery 100 and being communicated via the SMBus connection may include data elements such as smart battery status, manufacturer name, serial and model number, voltage, temperature and charge status.

The size and shape of the battery 100 illustrated substantially resembles a rectangular prism having a length L, a height H and a depth D. The exact dimensions may vary depending of the manufacturer and the number of cells included in a plurality of cells 110. In the depicted embodiment, the battery 100 includes 16 battery cells arranged in two sections, with a first section 102 containing 10 battery cells and a second section 104 containing 6 battery cells.

In one embodiment, a battery housing 120 encloses the contents of the battery 100 including the plurality of cells 110. Once enclosed within the battery housing 120, the cells 110 are generally not accessible to a user for repair or replacement without breaking the battery housing 120. In the depicted embodiment, the battery housing 120 shown has a length L of approximately 5.25″, a height H of approximately 1.5″ and a depth D of approximately 3.5″.

In one embodiment, the battery housing 120 is manufactured from a plastic material. The plastic material provides sufficient packaging strength to protect the contents of the battery 100 from damage during routine handling. In the depicted embodiment, the battery housing 120 is made from a clear plastic. It is desirable for the plastic material to be able to withstand high temperatures (of about 45 degrees Centigrade), which are typically caused during the charge cycle.

A terminal connector assembly 130 receives and/or sends electrical signals to external devices (not shown) through a plurality of electrical connectors or pins (not shown). For example, communication messages sent/received to/from the SMBus use the electrical connectors located on the terminal connector assembly 130.

FIG. 1B is a view in perspective of the battery 100 with a predefined number of cells removed, according to an embodiment. In the depicted embodiment, the predefined number of cells, which have been removed, is 4 out of a total of 16 battery cells. The removal of the predefined number of cells defines a selective portion 140 of the battery housing 120. That is, the selective portion 140 is prepared by removing the predefined number of cells from the plurality of cells 110 and the corresponding removal of the base portion and the top cover portion of the plastic wall of the battery housing 120. In the depicted embodiment, the outer side walls of the selective portion 140 includes one or more slots 145 as a means to lock externally inserted optional components (not shown).

The removal of the predefined number of cells may cause a corresponding reduction in the amount of power stored in the battery 100. The space created by the removal of cells and the corresponding upper and lower walls of the battery housing 110, is advantageously utilized to accommodate optional audio components such as a sub-woofer without affecting other components and/or the overall size of the portable device. The dimensions of the battery housing 120 remain unchanged, with or without the creation of the selective portion 140.

FIG. 1C is a view in perspective of a speaker container 150 suitable for housing a speaker assembly (not shown), according to an embodiment. The speaker container 150 is manufactured from a plastic material. The plastic material provides sufficient packaging strength to protect the contents of the speaker container 150 from damage during routine handling. In one embodiment, the speaker container 150 includes a speaker assembly (not shown). The speaker assembly includes a speaker (not shown), means to secure the speaker to the speaker container 150 and wires (not shown) to receive an audio input (not shown). The speaker, e.g., a sub-woofer, is operable to generate a sound output having a frequency range from about 20 Hertz to about 120 Hertz.

In the depicted embodiment, a base portion of the speaker container 150 includes a circular opening 147. The dimension of the circular opening preferably matches the dimension of the speaker. In this embodiment, the speaker container 150 includes one or more latches 152 located on the edges of the outer wall surface. It is desirable for the plastic material to be able to withstand high temperatures (of about 45 degrees Centigrade), which are typically caused during the battery charge cycle.

The exact size and shape of the speaker container 150, which is also described as an enclosure, is defined by the acoustical performance desired. Design of the speaker container 150, which determines the efficiency of the enclosure, is based on power and volume requirements of the speaker. In the depicted embodiment, the speaker container 150 shown has a length L of approximately 2.25″, a height H of approximately 1.5″ and a depth D of approximately 1.75″.

FIG. 1D is a view in perspective of the battery 100 and the speaker container 150 illustrating matching form factors to facilitate installation, according to an embodiment. In one embodiment the outer dimension of the speaker container 150 are slightly more than the corresponding inner dimension of the selective portion 140 to provide easy installation. The speaker container 150 may be secured to the selective portion 140 by latching means. In one embodiment, the speaker container 150 includes the one or more latches 152 located on the edges of the outer wall surface that lock into the corresponding matching slots 145 located on the selective portion 140.

Advantageously, the dimensions of the battery housing 120 remain unchanged, with or without the speaker container 150 being installed in the selective portion 140. Thus, a sub-woofer speaker may be added as an optional customer replaceable unit (CRU) by simply trading the capacity of the battery 100 for the improved audio performance. In addition, by accommodating the speaker container 150 in the selective portion 140 of the battery housing 120, the shock and vibration caused by the operation of the speaker has advantageously little or no effect on other sensitive components of the portable device such as hard disk drives (not shown).

FIG. 1E is a view in perspective of the battery 100 with the speaker container 150 being installed in the selective portion 140 of the battery housing 120, according to an embodiment. When the speaker container 150 is fully placed in the selective portion 140 and is secured by the latching means, the overall dimensions of the battery housing 120 having the speaker container 150 remain substantially unchanged.

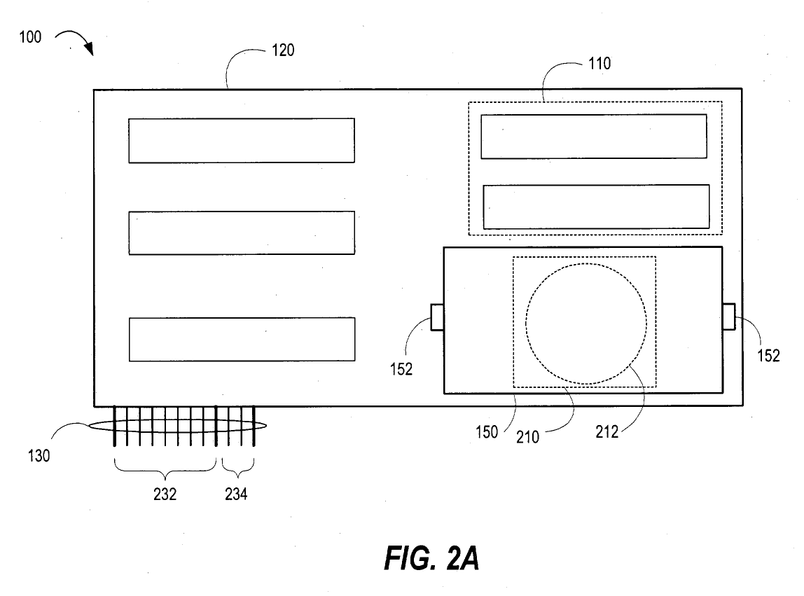

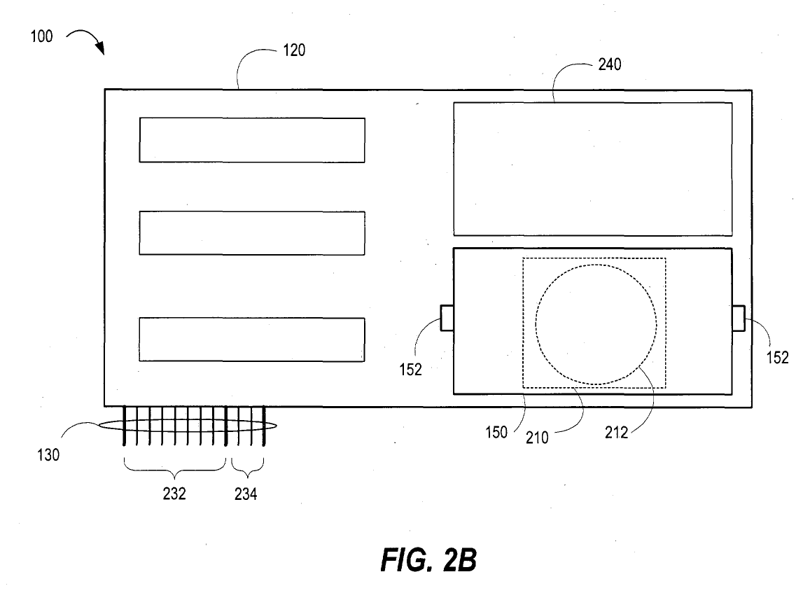

FIG. 2A illustrates a diagrammatic representation of the battery 100 for incorporating a speaker assembly 210, according to an embodiment. In one embodiment, the battery 100 includes: a) 12 battery cells, b) the speaker assembly 210 including a speaker 212 contained in the speaker container 150, and c) the terminal connector assembly 130.

In one embodiment, the terminal connector assembly 130 includes a first portion 232 having 9 pins and a second portion 234 having 3 pins. The pins may also be referred to as electrical connectors. The battery 100 sends and/or receives electrical signals to external devices such as a controller (not shown) or a charger (not shown) through the first portion 232. In one embodiment, the first portion 232 is used by a smart version of the battery 100 for communication on the SMBus. The speaker 212 receives audio and power signals from the portable device (not shown) through the second portion 234. The first and second portions 232 and 234 are electrically isolated.

FIG. 2B illustrates a diagrammatic representation of the battery 100 for incorporating the speaker assembly 210 and audio electronics 240, according to an embodiment. In the depicted embodiment, the speaker 212 receives audio signals from the audio electronics 240 located within another selective portion of the battery housing 120. In one embodiment, the battery 100 powers the audio electronics 240. In one embodiment, the portable device (not shown) powers the audio electronics 240.

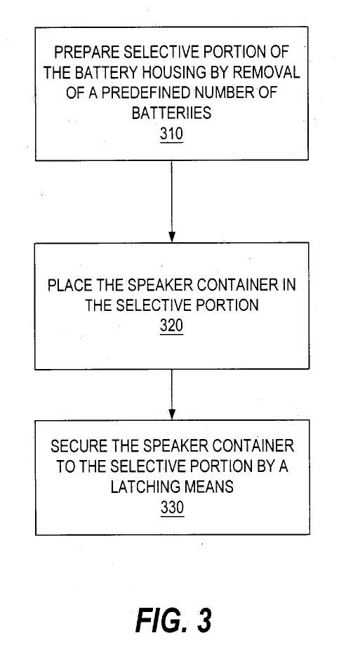

FIG. 3 is a flow chart illustrating a method for incorporating the speaker assembly 210 in a portable device of the information handling system. As described earlier, the battery 100 is enclosed in the battery housing 120 and the speaker assembly 210 is enclosed in the speaker container 150. In step 310, the selective portion 140 of the battery housing 120 is prepared. A predefined number of cells are removed from the plurality of cells to create space, which is sufficient to receive the speaker container 150. In step 320, the selective portion 140 receives the speaker container 150 by placing it in the selective portion so that the dimensions of the battery housing 120 having the speaker container 150 are substantially unchanged.

Various steps described above may be added, omitted, combined, altered, or performed in different orders. For example, a step 330 may be added to secure the speaker container 150 to the battery housing 120 by using the latching means.

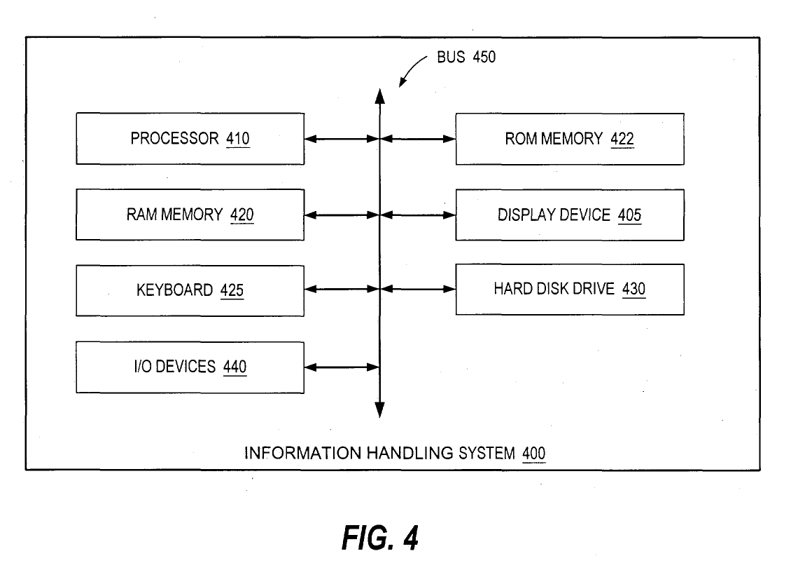

FIG. 4 illustrates a block diagram of an information handling system to implement method or apparatus aspects of the present disclosure, according to an embodiment. For purposes of this disclosure, an information handling system 400 may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, the information handling system 400 may be a personal computer, a network storage device, or any other suitable device and may vary in size, shape, performance, functionality, and price.

The information handling system 400 may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring to FIG. 4, the information handling system 400 includes a processor 410, a system random access memory (RAM) 420, a system ROM 422, a display device 405, a keyboard 425 and various other input/output devices 440. It should be understood that the term “information handling system” is intended to encompass any device having a processor that executes instructions from a memory medium. The information handling system 400 is shown to include a hard disk drive 430 connected to the processor 410 although some embodiments may not include the hard disk drive 430. The processor 410 communicates with the system components via a bus 450, which includes data, address and control lines. A communications device (not shown) may also be connected to the bus 450 to enable information exchange between the system 400 and other devices.

In one embodiment, the information handling system 400 may be used to implement the portable information handling system device (not shown) described in FIG. 1. The battery 100 (not shown) may be configured to provide power to the information handling system 400.

The processor 410 is operable to execute the computing instructions and/or operations of the information handling system 400. The memory medium, e.g., RAM 420, preferably stores instructions (also known as a “software program”) for implementing various embodiments of a method in accordance with the present disclosure. In various embodiments the one or more software programs are implemented in various ways, including procedure-based techniques, component-based techniques, and/or object-oriented techniques, among others. Specific examples include assembler, C, XML, C++ objects, Java and Microsoft Foundation Classes (MFC). For example, in one embodiment, the BIOS program described may be implemented using an assembler language code.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. In an information handling system, a method for incorporating a speaker assembly in a portable device of the information handling system, the portable device being operable to receive power from a battery having a plurality of cells, the battery being enclosed in a battery housing and the speaker assembly being enclosed in a speaker container, the method comprising:
preparing a selective portion of the battery housing, the selective portion being prepared to receive the speaker container by removal of a predefined number of cells from the plurality of cells; and
receiving the speaker container to be placed in the selective portion, wherein dimensions of the battery housing having the speaker container are substantially unchanged.

2. The method of claim 1, wherein the speaker assembly includes a speaker operable to output sound having a frequency range from about 20 Hertz to about 120 Hertz.

3. The method of claim 2, wherein an audio card of the at least one device is electrically coupled to the speaker.

4. The method of claim 2, wherein the speaker container substantially matches a form factor of the selective portion, wherein a base of the speaker container includes an opening to accommodate the speaker.

5. The method of claim 2, wherein a volume of the speaker container is sufficient to produce the output sound having the frequency range from about 20 Hertz to about 120 Hertz.

6. The method of claim 1, wherein the battery and the speaker assembly are each electrically coupled to a terminal connector assembly having a plurality of electrical connectors, wherein the battery is coupled to a first portion of the plurality of the electrical connectors for transferring the power, wherein the speaker assembly is coupled to a second portion of the plurality of the electrical connectors for receiving a sound input, and wherein the first portion and the second portion are electrically isolated.

7. The method of claim 1, wherein the battery housing and the speaker container comprises a plastic material.

8. The method of claim 1, wherein the incorporation of the speaker assembly in the portable device does not affect other components included in the portable device except for the battery.

9. The method of claim 1, wherein the incorporation of the speaker assembly in the portable device does not affect an overall size of the portable device.

10. The method of claim 1, wherein the portable device is defined to include the speaker assembly as an option.

11. A battery operable to provide power to a portable device of an information handling system, the battery comprising:
a plurality of cells housed in a battery housing, wherein a predefined number of cells included in the plurality of cells are removable to define a selective portion of the battery housing; and
a speaker assembly housed in a speaker container, wherein the speaker container is installable in the selective portion, wherein dimensions of the battery housing having the speaker container installed in the selective portion are substantially unchanged.

12. The battery of claim 11, comprising:
a terminal connector assembly having a plurality of electrical connectors, wherein the battery is electrically coupled to a first portion of the plurality of the electrical connectors for providing the power, wherein the speaker assembly is electrically coupled to a second portion of the plurality of the electrical connectors for receiving an audio output signal generated by the device, and wherein the first portion and the second portion are electrically isolated.

13. The battery of claim 11, wherein the speaker assembly includes a speaker operable to output sound having a frequency range from about 20 Hertz to about 120 Hertz.

14. The battery of claim 13, wherein an audio card of the portable device is electrically coupled to the speaker.

15. The battery of claim 13, wherein the speaker container substantially matches a form factor of the selective portion, wherein a base of the speaker container includes an opening, the opening substantially matching dimensions of the speaker.

16. The battery of claim 13, wherein a volume of the speaker container is sufficient to produce the output sound having the frequency range from about 20 Hertz to about 120 Hertz.

17. The battery of claim 11, wherein the battery housing and the speaker container comprises a plastic material.

18. The battery of claim 11, wherein the installation of the speaker assembly in the portable device does not affect other components included in the portable device except for the predefined number of cells.

19. The battery of claim 11, wherein the installation of the speaker assembly in the portable device does not affect an overall size of the portable device.

20. The battery of claim 11, wherein the portable device is defined to include the speaker assembly as an option.

21. An information handling system comprising:
a processor;
a system bus;
a memory coupled to the processor through the system bus;
an audio card coupled to the processor and the memory through the system bus;
a battery system operable to provide power to the processor, the bus and the memory, the battery being connectable to an AC adapter for deriving power from an AC power source; and
wherein the battery system includes:
a plurality of cells housed in a battery housing, wherein a predefined number of cells included in the plurality of cells are removable to define a selective portion of the battery housing; and
a speaker assembly housed in a speaker container, wherein the speaker container is installable in the selective portion, wherein dimensions of the battery housing having the speaker container installed in the selective portion are substantially unchanged.

22. The system of claim 21, comprising:
a terminal connector assembly having a plurality of electrical connectors, wherein the battery system is electrically coupled to a first portion of the plurality of the electrical connectors for providing the power, wherein the speaker assembly is electrically coupled to a second portion of the plurality of the electrical connectors for receiving an audio output signal generated by the audio card, and wherein the first portion and the second portion are electrically isolated.

23. An information handling system comprising:
a chassis;
a microprocessor mounted in the chassis;
a storage coupled to the microprocessor;
a battery system operable to provide power to the system, the battery being connectable to an AC adapter for deriving power from an AC power source; and
wherein the battery system includes:
a plurality of cells housed in a battery housing, wherein a predefined number of cells included in the plurality of cells are removable to define a selective portion of the battery housing; and
a speaker assembly housed in a speaker container, wherein the speaker container is installable in the selective portion, wherein dimensions of the battery housing having the speaker container installed in the selective portion are substantially unchanged.
